(19) United States
(12) Patent Application Publication
(10) Pub. No.: US 2007/0104925 A1
(43) Pub. Date: May 10, 2007

(54) Soft-hard moulded articles

(76) Inventors: Hans-Jurgen Huber, Usingen (DE); Karl-Wilhelm Kirberg, Neu-Anspach (DE); Angelo Polese, Falkensee (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/588,926

(22) Filed: Oct. 27, 2006

Related U.S. Application Data
(60) Provisional application No. 60/734,603, filed on Nov. 8, 2005.

(51) Int. Cl. B32B 23/02

(52) U.S. Cl. 428/192; 264/328.1; 264/328.8

(57) ABSTRACT

The invention provides a method for injection moulding thermoplastic articles having both soft and hard zones.

### CROSS REFERENCE TO RELATED APPLICATIONS

This application claims the benefit of priority to U.S. Provisional Application No. 60/734,603 filed Nov. 8, 2005.

### FIELD OF THE INVENTION

The invention relates to the field of polymers, particularly moulded articles made of polymer blends, having distinct soft and hard zones when injection moulded.

### BACKGROUND OF THE INVENTION

Polyester resins, such as polyethylene terephthalate (PET) and polybutylene terephthalate (PBT), and copolyether ester block copolymer elastomers have, for many years, been commonly used to form articles of all sizes and shapes. Each group of materials has its own advantages and drawbacks. More specifically, the PBT and PET polyester resins generally yield products having high rigidity and good resistance to corrosive chemicals. In contrast, copolyether ester elastomers are renowned for their flexibility, resistance to fatigue and soft touch characteristics.

Many mechanical and electrical components comprise pluralities of functional parts requiring a combination of such rigid and flexible materials. Examples of such articles include any article that requires structural rigidity, while at the same time requiring a soft or flexible edge which may act as a sealing element. The rigid part often is required to bear weight, or provide structural support. In contrast, the sealing element must have a degree of softness (flexibility) enabling it to conform to the surface with which it will form a seal.

A common approach to making such articles is to mould the rigid and flexible components separately and glue them together. This requires two moulds, and also requires additional assembly and gluing steps after moulding of the two components. In addition, lack of good adhesion of the rigid and flexible components is a common problem.

Another approach is so-called “two-shot moulding”, or “overmoulding” in which a two-component piece is injection moulded in two steps: 1) a rigid thermoplastic material is injection moulded from a first melt into a first part of a mould, and 2) before solidification of the rigid thermoplastic material, a softer thermoplastic material is injection moulded from a second melt into the unfilled parts of the mould. The result is an article having rigid and flexible components. A drawback to this approach is that the moulds must be complicated, and adhesion of the rigid and flexible components may be poor.

Another approach to combining rigid polyester resins and flexible elastomers is the use of multicomponent thermoelastic elastomer compositions, for example a composition containing PET or PBT, an epoxy group containing ethylene copolymer, specific polyfunctional compounds and a block copolyether ester elastomer, as disclosed in U.S. Pat. No. 5,405, 909.

WO 02/32998 describes mono-component moulded compositions consisting of a blend of a soft copolyether ester elastomer and a hard polyester resin reinforced with a fibrous or particulate filler. During moulding of an article, the two polymers separate somewhat, resulting in reinforced polyester towards the centre of the moulded article and copolyether ester towards the surface. Moulded articles made from the compositions are said to have excellent noise-damping characteristics.

There remains a need for improved methods for producing moulded articles having both soft and hard components.

### SUMMARY OF THE INVENTION

In a first aspect, the invention provides a method for injection moulding an article having soft zones and hard zones, comprising the steps:
melt-processing a cube blend of a soft polymer and a hard polymer at or above the melting point of the hard polymer, to form a molten polymer blend;
injecting the molten polymer blend into a mould having at least one thick part and at least one thin part, wherein the injection gate or gates in the mould are located in the thick part;
decreasing the injection pressure for a period of time sufficient to allow the molten polymer to crystallise in the thin part of the mould; and
increasing the injection pressure to finish filling the mould.

In a second aspect, the invention provides an injection moulded single component thermoplastic article comprising a blend of a hard polymer and a soft polymer, wherein the article has at least one thinner sealing edge having a relatively higher proportion of soft polymer, and a thicker structural part having a relatively higher proportion of the hard polymer.

### DETAILED DESCRIPTION OF PREFERRED EMBODIMENTS

### BRIEF DESCRIPTION OF THE DRAWINGS

FIG. 1 shows a cover for a gear housing made according to the method of the invention.

FIG. 2 shows a cover for a container made according to the method of the invention.

FIG. 3 shows a cover for a gear housing made according tot the method of the invention, showing dimensions.

The invention provides a new and simple method for producing moulded articles having a soft and hard component. The new method does not require assembly and/or adhesion of the soft and components with glue, and it does not require a two-step injection moulding process.

The process of the invention involves melt-processing a cube-blend of a soft polymer and hard polymer, wherein the soft polymer has a lower melting point than the hard polymer, at a temperature at or above the melting point of the hard polymer, and preferably at least 30° C. above the melting point of the soft polymer. The process then uses an injection moulding profile in which, after an initial injection phase, there is a “pause phase” at decreased pressure, followed by a “holding phase” at increased pressure. While not wishing to be limited by theory, it is believed that during the initial injection, the softer polymer, which has a greater melt flow rate than the hard polymer at the melt temperature, more readily enters the thin part or parts of the mould. During the pause, the soft polymer in the thin part or parts of the mould crystallises or partially solidifies, so as not to be displaced by molten polymer when the pressure is raised during the final holding time. During the holding time, the thick part of the mould is filled with hard polymer and the hard polymer solidifies.

The result is a part in which the thin part comprises mostly the soft polymer, and the thick part comprises mostly hard polymer. This is contrary to conventional moulding practices where it is usually sought to obtain a homogeneous final structure. In the process of the invention, the soft polymer and the hard polymer have a mismatch of melting point, viscosity and modulus so as to make possible the inhomogeneous structure, but the two polymers maintain sufficient compatibility to bond well together after resolidification.

In the process of the invention a cube blend of a soft and a hard polymer is used as the raw material. The expression “cube blend” is meant to encompass any mixture comprising the soft polymer and the hard polymer as separate solids, for example, pellets of the soft polymer mixed with pellets of the hard polymer, or the soft polymer as a powder mixed with the hard polymer as a powder, or granules of the soft polymer mixed with granules of the hard polymer, or any permutation or combination of these.

The hard and soft polymers must be compatible. The expression “compatible” means that if the soft and hard polymers are vigorously mixed in a molten state, an essentially homogeneous blend is eventually obtained, and separation into two phases does not occur. The hard and soft polymers are chosen so that the hard polymer has a melting point higher than the melting point of the soft polymer. Preferably the hard polymer has a melting point that is at least at or about 30° C. above the melting point of the soft polymer, more preferably at least at or about 40° C. above the melting point of the soft polymer. In a preferred embodiment, the hard polymer has a melting point that is at or about 30° C. above the melting point of the soft polymer.

The melt temperature is controlled to be at least at or about the melting point of the hard polymer, and more preferably at or about 20, 40, or 50° C. above the melting point of the hard polymer, with order of preference increasing with higher temperature. In this way, the hard polymer is molten, and the soft polymer is well above its melting point. The molten soft polymer will therefore have a much higher Melt Flow Rate than the molten hard polymer, and will more readily flow into the mould, particularly the thin part or parts of the mould.

Melt Flow Rate can be measured according to the standard ISO 1133:1997. Preferably the ratio of the Melt Flow Rate of the soft polymer to the Melt Flow Rate of the hard polymer (soft:hard) at the melt temperature is at least or about 2, more preferably at least at or about 3 or 4.

Examples of some suitable hard/soft polymer pairs are shown below in Table 1.

TABLE 1
Examples of hard/soft polymer pairs that
can be used to practise the invention

| Hard polymer | Soft polymer |
|---|---|
| Polyesters | copolyether ester elastomer |
| e.g. PBT, PPT, PET, PCT, | e.g. Hytrel ®, Arnitel ®, Riteflex ® |
| PEN, mixtures thereof | |
| Polyamides | Ionomers |
| e.g. Nylon 6, nylon 6, | e.g. random copolymers of ethylene and |
| 6 nylon 6, 12, nylon 12 | methacrylic acid [poly(ethylene-co- |
| | methacrylic acid)], Surlyn ® |
| Polyacetal (POM) | Thermoplastic polyurethane |
| PBT, PET | ETPV |

Abbreviations
PBT: polybutylene terephthalate
PPT: polypropylene terephthalate
PET: polyethylene terephthalate
PCT: poly[1,4-cyclohexylenedimethylene]terephthalate
PEN: poly(ethylene-2,6-naphthalate)
POM: polyoxymethylene (polyacetal)
ETPV: engineering thermoplastic vulcanisate: (a) from 15 to 60 wt % of a polyalkylene phthalate polyester polymer or copolymer and; (b) from 40 to 85 wt % of a cross-linkable poly(meth)acrylate or polyethylene/(meth)acrylate vulcanisate rubber in combination with an effective amount of peroxide free-radical initiator and an organic diene co-agent to cross-link the rubber during extrusion or injection moulding of the curable thermoplastic elastomeric blend.
PPG: polypropylene glycol
PEG: polyethylene glycol

In one embodiment, the soft polymer is a copolyether ester elastomer, which generally consists essentially of a multiplicity of recurring long chain ester units and short chain ester units joined head-to-tail through ester linkages. The long chain ester units are represented by the formula: 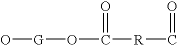
and the short chain ester units are represented by the formula: 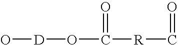
where G is a divalent radical remaining after removal of terminal hydroxyl groups from a poly(alkylene oxide) glycol [preferably poly(propylene oxide) glycol, or poly(butylene oxide) glycol] having a molecular weight of at or about 400-6000 Da and a carbon-to-oxygen ratio of about 2.0-4.3; R is a divalent radical remaining 4 after removal of carboxyl groups from a dicarboxylic acid having a molecular weight of less than at or about 300 and D is a divalent radical remaining after removal of hydroxyl groups from a diol having a molecular weight of less than at or about 250; provided said short chain ester units amount to about 15-95% by weight of the copolyether ester.

Particularly preferred copolyether esters are: a copolyether ester consisting of PBT “hard” segments and PEG-capped PPG “soft” segments. More particularly preferred are those copolyether esters having the following characteristics:

| Property | Test method | Units | Value |
|---|---|---|---|
| Tensile stress @ 10% | ISO 527-1/-2 | MPa | 2.5 |
| strain | | | |
| Stress at break | ISO 527-1/-2 | MPa | 9.7 |
| Strain at break | ISO 527-1/-2 | % | 240 |
| Tensile modulus | ISO 527-1/-2 | MPa | 23 |
| Flexural modulus | | | |
| −40° C. | ISO 178 | MPa | 50 |
| 23° C. | | | 32 |
| 100° C. | | | 7 |
| Hardness, Durometer D | | | |
| 15 s | ISO 868 | | 26 |
| Maximum | | | 35 |
| Notched Izod Impact | ISO 180/1A | kJ/m² | NB |
| Strength −40° C. | | | |
| Brittleness temperature | ISO 974 | ° C. | −61 |
| Initial tear resist., die C | ISO 34 | kN/m | 58 |
| parallel | | | |
| Melting temperature | | | |
| 10° C./min | ISO 11357-1/-3 | ° C. | 154 |
| Vicat softening | ISO 306 | ° C. | 73 |
| temperature 10 N, | | | |
| 50° C./h | | | |
| Melt mass-flow rate | ISO 1133 | g/10 min | 10 |
| 190° C., 2.16 kg | | | |
| Density | ISO 1183 | Kg/m³ | 1150 |
| Water absorption, | ISO 62 | % | 5 |
| immersion 24 h | | | |

Test specimen for ISO 527-1/-2 is 1BA (2 mm) at 50 mm/min; all other ISO mechanical properties measured at 4 mm; ISO electrical properties measured at 2 mm.
All mechanical & electrical properties measured on injection-moulded specimens.
Test temperatures are 23° C. unless otherwise stated.

Copolyether ester elastomers are described for example in U.S. Pat. Nos. 4,981,908, 5,824,421 and 5,731,380, the descriptions whereof are incorporated herein by way of reference. Copolyether ester block copolymers and their preparation are also described in Encyclopaedia of Polymer Science and Engineering, Volume 12, pages 76-177 (1985) and the references reported therein. Various copolyether ester block copolymer elastomers are commercially available from a number of companies under various tradenames, for example HYTREL of E.I. du Pont de Nemours and Company, RITEFLEX of Ticona and ARNITEL of DSM.

The ratio hard/soft segment in the block copolyether ester elastomer may be varied and different alkylene oxides and molar weights of the soft segments may be used, in order to obtain block copolyether ester elastomers having different hardnesses, for example mostly between at or about Shore D 30 and 80. For the present invention, for the soft polymer, preference is for the softer elastomers, e.g. with a hardness from at or about Shore D 30 to 60.

Particularly preferred soft polymers are the following (including mixtures of these):

A copolyether ester elastomer having a melt flow rate of 4.5 g/10 min at 220° C. under 2.16 kg load, a flexural modulus of 55 MPa at 23° C. and a melting point of 195° C.

A copolyether ester elastomer having a melt flow rate of 10.0 g/10 min at 190° C. under 2.16 kg load, a flexural modulus of 32.4 MPa at 23° C. and a melting point of 156° C.

A copolyether ester elastomer having a melt flow rate of 5.3 g/10 min at 190° C. under 2.16 kg load, a flexural modulus of 62 MPa at 23° C. and a melting point of 150° C.

A copolyether ester elastomer having a melt flow rate of 7.5 g/10 min at 220° C. under 2.16 kg load, a flexural modulus of 207 MPa at 23° C. and a melting point of 203° C.

A copolyether ester elastomer having a melt flow rate of 8.5 g/10 min at 230° C. under 2.16 kg load, a flexural modulus of 330 MPa at 23° C. and a melting point of 211° C.

A copolyether ester elastomer having a melt flow rate of 12.5 g/10 min at 240° C. under 2.16 kg load, a flexural modulus of 570 MPa at 23° C. and a melting point of 218° C.

The hard polymer is advantageously filled with a filler or reinforcement, preferably a fibrous filler. Examples include glass fibre, carbon fibres, graphite fibres, aramid fibres, ceramic fibres, metal fibres, potassium titanate whiskers, etc. Preferred fibres have an aspect ratio of from at or about 10 to at or about 1000. The reinforcing filler promotes the segregation of the soft polymer in the thin part of the mould. Without wishing to be bound by any theory, it is believed that the filler forms, during initiation of the moulding process, a reinforced matrix in which the hard polymer is retained but from which the soft polymer, due to its lower melting point and its lower viscosity, is able to segregate.

Advantageously, the filler makes up between 5 and 60% by weight of the hard polymer, usually between 10 and 50%. Normally, the amount of the filler will correspond to between about 2.5% and 30% by weight of the final moulded composition, usually between 5% and 20%.

In one embodiment, particularly preferably when the soft polymer is a copolyether ester elastomer, the hard polymer is a polyester, including PCT, PET, PPT and PBT. The hard polyester resin typically is comprised of a single polyester resin, preferably PBT, although a blend of more than one polyester resin is possible. The polyester resin itself should have a flex modulus of at least 2.0 GPa for the PBT polymer or 10 GPa when glass-fibre reinforcement is included, and a melting point in the range 210-230° C. (for example, PBT) or up to 260° C. (for example, PET).

A particularly preferred hard polymer is a PBT. More particularly preferred are those PBT's having the following characteristics:

| Property | Test method | Units | Value |
|---|---|---|---|
| Stress at break | ISO 527 | MPa | 130 |
| Strain at break | ISO 527 | % | 2.5 |
| Tensile modulus | ISO 527 | MPa | 9600 |
| Flexural strength | ISO 178 | MPa | 200 |
| Notched Charpy Impact | ISO 179/1eA | kJ/m² | 10 |
| Strength −40° C. | | | |
| unnotched Charpy Impact | ISO 179/1eU | kJ/m² | 65 |
| Strength −40° C. | | | |
| Deflection temperature | ISO 75f | ° C. | 205 |
| 1.80 MPa | | | |
| Melting temperature | ISO 11357-1/-3 | ° C. | 225 |
| 10° C./min | | | |

ISO mechanical properties measured at 4 mm; All mechanical & electrical properties measured on injection-moulded specimens.
Test temperatures are 23° C. unless otherwise stated.

Particularly preferred hard polymers (advantageously used with copolyether esters as the soft polymer) have the following characteristics (including mixtures). All of the hard polymers listed below may be used according to the invention with any of the soft polymers mentioned above:

A thermoplastic polyester based on polybutylene terephthalate (PBT) reinforced with 50% by weight of reinforcing glass fibres, having a tensile modulus of 1600 MPa at 23° C. and a melting point of 225° C.

A thermoplastic polyester based on polybutylene terephthalate (PBT) reinforced with 20% by weight of reinforcing glass fibres, having a tensile modulus of 7500 MPa at 23° C. and a melting point of 225° C.

A thermoplastic polyester based on polybutylene terephthalate (PBT) reinforced with 50% by weight of reinforcing glass fibres, having a tensile modulus of 16000 MPa at 23° C. and a melting point of 225° C.

A thermoplastic polyester based on polybutylene terephthalate (PBT) containing SAN and reinforced with 20% by weight of reinforcing glass fibres, having a tensile modulus of 7500 MPa at 23° C. and a melting point of 220° C.

A polyamide 66 containing 25% by weight of reinforcing glass fibres, conditioned by picking up about 2.5% by weight of moisture.

PA 66-2: a toughened polyamide 6 containing 30% by weight of reinforcing glass fibres, conditioned by picking up about 2.5% by weight of moisture.

PA 66-1: a supertough polyamide 66 containing 33% by weight of reinforcing glass fibres.

A thermoplastic polyester based on polyethylene terephthalate (PET) reinforced with 30% by weight of reinforcing glass fibres.

A polyoxymethylene which is a POM homopolymer obtained by the polymerisation of formaldehyde.

In another embodiment, the soft polymer is selected from ionomers, in particular, random copolymers of ethylene and methacrylic acid [poly(ethylene-co-methacrylic acid)]. The acid moieties may be protonated, but are preferably neutralised from at or about 10 to 100 mol %, more preferably from at or about 25-80 mol %, particularly preferably at or about 30-70 mol %, with a counterion selected from Na⁺ and Zn⁺⁺, with Na⁺ preferred. A particularly preferred ionomer comprises 50-95% by weight of ethylene, 5-15% by weight of acrylic acid or methacrylic acid, and 0-35% by weight of a moiety selected from at least one of methyl acrylate, iso-butyl acrylate and n-butyl acrylate, and the acid groups are neutralized from 30-70% with a counterion of at least one metal ion selected from sodium and zinc, preferably sodium. Suitable ionomer may be purchased under the trade name Surlyn® (DuPont, Wilmington, USA).

In one embodiment, particularly preferably when the soft polymer is an ionomer, the hard polymer is a polyamide, such as, for example, nylon 6, nylon 6,6 nylon 6,12, nylon 12, and mixtures or copolymers of these.

The soft polymer and/or the hard polymer may of course contain additives, for example stabilizers, dyes or pigments, fillers, flame-retardants or processing aids such as release agents.

Preferred compositions according to the invention typically comprise from 20 to 70 wt % of the soft polymer (e.g. copolyester ether elastomer) and from 30 to 80 wt % of the hard polymer (e.g. polyester resin), based on the total weight of the composition and, for most applications, contain from 30 to 60 wt % of soft polymer (e.g. copolyether ester elastomer) and from 40 to 70 wt % of the hard polymer (e.g. polyester resin).

Preferably the hard polymer, is glass-fibre filled, particularly preferably at or about 30 wt % glass-fibre filled. A particularly preferred hard polymer is the PBT Crastin® SK 605 (DuPont). A particularly preferred soft polymer is the copolyether ester Hytrel® 3548 (DuPont). When these components are used together, a melt temperature of at or about 250° C. gives good results.

The process of the invention involves injection moulding the molten polymer material created by melting a cube blend of the hard and soft polymers. The injection moulding is carried out in three phases:
(1) an initial injection phase, preferably at a pressure chosen for conventional injection moulding of the hard polymer, P₁;
(2) a pause phase, in which the pressure is decreased to a pressure at least at or about P₁/20; and
(3) a holding phase, in which the pressure is increased to a pressure of at or about P₁/5 to at or about P₁/3.

The pressure P₁ will depend on the part to be made, but in general is between at or about 900 to 2000 bar, more preferably at or about 1000 bar. The pressure during the pause is preferably at or about 45 to 100 bar, more preferably at or about 50 bar. The pressure during the holding phase is preferably at or about 180 to 660 bar, more preferably at or about 200 to 300 bar.

The mould is constructed to have at least one “thin part”, where it is desired to have soft or flexible characteristics in the finished moulded piece, and at least one thicker part, where it is desired to have rigid characteristics in the finished moulded piece. The injection gate or gates are in the thicker part or parts, so that the molten polymer material enters the thicker part(s) and flows into the thinner part(s). If there are multiple gates, they should preferably be distributed in a symmetrical fashion in the thick part. Preferably the ratio of the thickness of the “thin part” to the “thick part” (thin:thick) should be less than at or about 1:4. The thick part should preferably have a thickness of less than at or about 6 mm, preferably between at or about 1-5 mm. The thickness and ratios of thickness refer to average values, and some variation over the part is possible. The thin part should preferably have a thickness of less than at or about 0.2 to 2 mm. Some examples of thickness of the thin and thick parts are given in Table 2.

TABLE 2
Examples of average thickness of “thick part” and
“thin part” in the mould

| Average thickness of “thick part” | Average thickness of “thin part” | |
|---|---|---|
| 6 mm | ≦1.5 | mm |
| 4 mm | ≦1 | mm |
| 2 mm | ≦0.5 | mm |

During the initial injection (1), the soft polymer, which is less viscous at the melt temperature than the hard polymer, flows into the thin part of the mould. The pressure chosen for the initial injection (1) is a pressure suitable for filling an injection mould if the hard polymer were used alone. For example, when a polyester, such as PBT, is used as the hard polymer, and a copolyether ester elastomer is used as the soft polymer, the initial injection may be carried out at about 1000 bar. During the pause (2) the soft polymer that has flowed into the thin part of the mould solidifies. During the holding phase (3) the mould is filled with more polymer (mostly hard polymer), and the entire piece solidifies.

The length of time for each of the phases of the injection (the initial injection, the pause and the holding phase) depends on the pressure and the volume of the mould to be filled. If the pressure is high, more polymer flows into the mould. If the volume of the mould is large, it will take more polymer to fill it, hence a longer time. In general, the following ranges provide good results: initial injection phase for at or about 0.5 to 1.5 seconds, preferably at or about 1 second; pause phase for at or about 0.5 to 1.5 seconds, preferably at or about 1 second; and holding phase for at least at or about 2.5, preferably at or about 5 seconds. The holding phase may be continued as long as desired, however, it is usually desired to eject the moulded article as soon as possible so that a new cycle can begin.

The method of the invention is particularly suited for making parts in which it is desired to have a sealing component and a more rigid structural component. A particular example consists of an end-piece for a housing for gears, for example, as used in a window lifter. The housing contains the gears and protects them from dust, water, chemicals, as well as protecting the user from the gears. The end of the gearbox is closed with a cover, through which an axle or shaft, which must be free to rotate, exits the housing. To prevent egress of water, humidity, dust, etc., into the housing the axle or shaft is normally surrounded by a sealing element. In conventional gearboxes, the housing and the cover for the housing are moulded from a rigid thermoplastic, such as PBT, and the sealing element is made from an elastomeric polymer, such as a copolyether ester or a rubber. The sealing component must be assembled with the rigid component, and held in place with an adhesive.

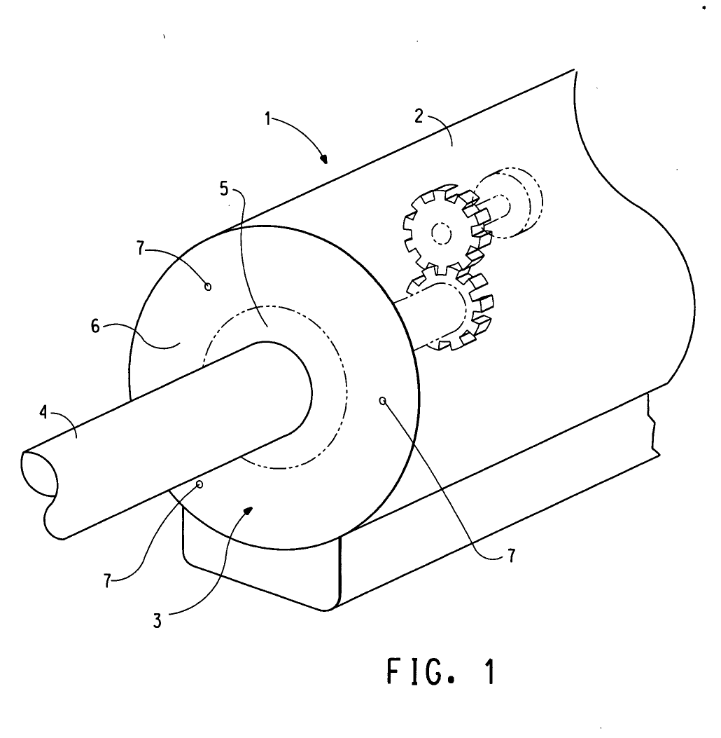

Using the method of the invention, it is possible to make the cover for the housing in a single step. An example is shown in FIG. 1. A gearbox housing (1) has a cylindrical body (2), with a cover (3) at one end. The cover (3) is moulded according to the method of the invention. The cover (3) for the gearbox has a circular hole at its centre, through which a shaft (4) protrudes. The cover (3) consists of a thinner sealing zone (5), at its inner circumference surrounding the shaft (4), with a relatively high amount of soft polymer (e.g. copolyether ester) and a thicker structural zone (6) at its outer circumference, with a relatively high content of hard polymer (e.g. PBT, or glass-filled PBT). The thinner part (5) forms a sealing part around the shaft (4), thus avoiding egress of dust and water to the gears. The mould part for the thinner part (5), which will surround the shaft, is made thinner than the mould part for the thicker structural part (6). The injection gates in the mould are located symmetrically in the thick part (6) around the circumference of the thick part (6). The sites of the injection gates are indicated with the numeral (7).

Other moulded articles that may be made with the method of the invention include:

Covers for containers which require an airtight, dust-tight, oil-tight, watertight, chemical-tight or bacteria-tight seal (such as battery housings, oil reservoirs, incubators, contact lens containers, food containers, cosmetic containers, containers for medical equipment, motor housings, gear housings, bearing housings, electronic housings, etc.).

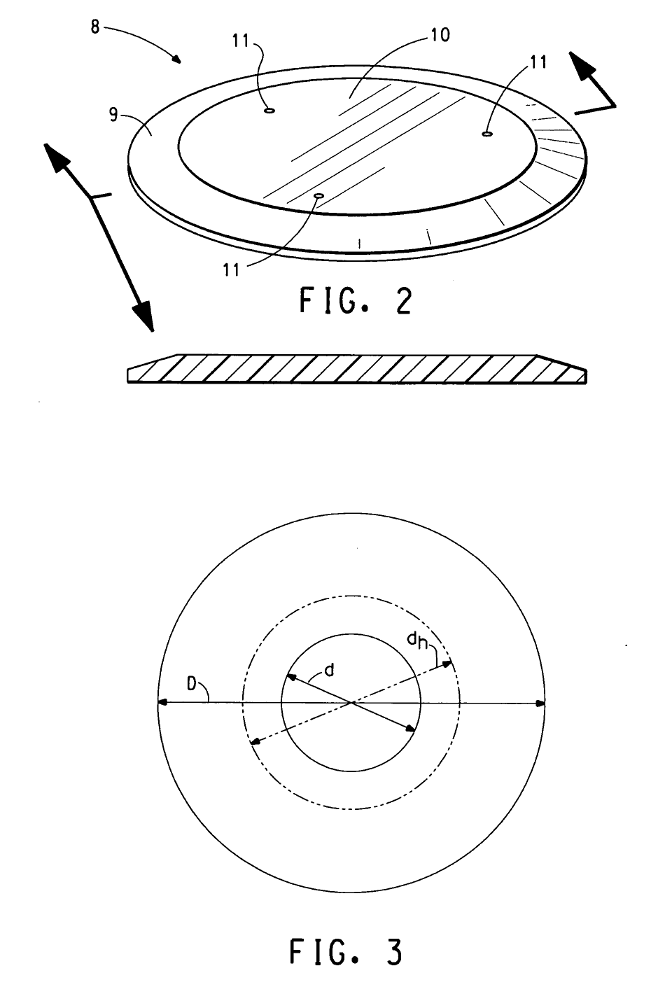

An example of a simple cover is shown in FIG. 2. A cover (8) has a sealing zone (9) at the circumference, which is thinner that the structural zone (10) towards the centre of the cover (8). The sealing zone consists mostly of soft polymer (for example copolyether ester), and the structural zone consists mostly of hard polymer (for example, PBT). The cover (8) is made using a mould in which the edges of the mould which will form the sealing zone (9) are thinner than the interior parts of the mould which will form the thicker structural part (10). The injection gates are located symmetrically in the thicker structural part (10). The sites of the injection gates are indicated in FIG. 2 with the numeral (11).

### EXAMPLE 1

A cover for a gearbox housing was made using the method of the invention, and is shown in FIG. 1 with the numeral (3).

The article had the following approximate dimensions as shown in FIG. 3:
D=outer diameter=7 cm;
d=inner diameter=2.5 cm;
d_{H}=inner diameter of hard part=4 cm
T_{H}=average thickness of hard part=4 mm
T=average thickness of soft part=1 mm

The mould was constructed to have three gates, the locations of which are indicated in FIG. 1 with the numeral (7).

The cube blend that was used consisted of a blend of granules of 30 wt % glass-fibre filled Crastin® SK 605 (DuPont) at 80 wt % and Hytrel® 3548 (DuPont) at 20 wt %.

Crastin® SK 605 is PBT filled with 30 wt % glass fibre, and having the following characteristics:

| Property | Test method | Units | Value |
|---|---|---|---|
| Stress at break | ISO 527 | MPa | 130 |
| Strain at break | ISO 527 | % | 2.5 |
| Tensile modulus | ISO 527 | MPa | 9600 |
| Flexural strength | ISO 178 | MPa | 200 |
| Notched Charpy Impact | ISO 179/1eA | kJ/m² | 10 |
| Strength −40° C. | | | |
| unnotched Charpy Impact | ISO 179/1eU | kJ/m² | 65 |
| Strength −40° C. | | | |
| Deflection temperature | ISO 75f | ° C. | 205 |
| 1.80 MPa | | | |
| Melting temperature | ISO 11357-1/-3 | ° C. | 225 |
| 10° C./min | | | |

ISO mechanical properties measured at 4 mm; All mechanical & electrical properties measured on injection-moulded specimens.
Test temperatures are 23° C. unless otherwise stated.

Hytrel® 3548 is a copolyether ester having PEG-capped PPG soft segments and PBT hard segments, having the following characteristics:

| Property | Test method | Units | Value |
|---|---|---|---|
| Tensile stress @ 10% | ISO 527-1/-2 | MPa | 2.5 |
| strain | | | |
| Stress at break | ISO 527-1/-2 | MPa | 9.7 |
| Strain at break | ISO 527-1/-2 | % | 240 |
| Tensile modulus | ISO 527-1/-2 | MPa | 23 |
| Flexural modulus | | | |
| −40° C. | ISO 178 | MPa | 50 |
| 23° C. | | | 32 |
| 100° C. | | | 7 |
| Hardness, Durometer D | | | |
| 15 s | ISO 868 | | 26 |
| Maximum | | | 35 |
| Notched Izod Impact | ISO 180/1A | kJ/m² | NB |
| Strength −40° C. | | | |
| Brittleness temperature | ISO 974 | ° C. | −61 |
| Initial tear resist., die C | ISO 34 | kN/m | 58 |
| parallel | | | |
| Melting temperature | | | |
| 10° C./min | ISO 11357-1/-3 | ° C. | 154 |
| Vicat softening | ISO 306 | ° C. | 73 |
| temperature 10 N, | | | |
| 50° C./h | | | |
| Melt mass-flow rate | ISO 1133 | g/10 min | 10 |
| 190° C., 2.16 kg | | | |
| Density | ISO 1183 | Kg/m³ | 1150 |
| Water absorption, | ISO 62 | % | 5 |
| immersion 24 h | | | |

Test specimen for ISO 527-1/-2 is 1BA (2 mm) at 50 mm/min; all other ISO mechanical properties measured at 4 mm; ISO electrical properties measured at 2 mm.
All mechanical & electrical properties measured on injection-moulded specimens.
Test temperatures are 23° C. unless otherwise stated.

The cube blend was melt-processed in an injection-moulding machine, with the temperature of the melt controlled to be about 250° C.

The following injection cycle was found to be good for a article having a thick part of thickness 4 mm and a thin part of thickness 1 mm, a volume of the thick part of at or about 10.37 cm³, and a volume of the thin part of at or about 0.298 cm³:
Initial injection phase at 1000 bar for 1 second;
Pause phase at ambient pressure for 1 second; and
Holding phase at 200-300 bar for 5 seconds.

Referring to FIG. 1, the resulting moulded article (3) had essentially copolyether ester localised around the sealing zone (5), and gradually less and less copolyether ester in moving radially outward to the structural zone (6). The outer edges of the structural zone (6) were essentially PBT.

1. A method for injection moulding an article having soft zones and hard zones, comprising the steps:
melt processing a cube blend of a soft polymer and a hard polymer at or above the melting point of the hard polymer, to form a molten polymer blend;
providing a mould having at least one thick part and at least one thin part, wherein the injection gate or gates in the mould are located in the thick part;
in an initial injection phase, injecting the molten polymer blend into the mould;
in a pause phase, decreasing the injection pressure for a period of time sufficient to allow the molten polymer to crystallize in the thin part of the mould; and
in a holding phase, increasing the injection pressure to finish filling the mould.

2. The method of claim 1, wherein the hard polymer has a melting point that is at least at or about 30° C. above the melting point of the soft polymer.

3. The method of claim 1, wherein the hard polymer has a melting point that is at or about 40° C. above the melting point of the soft polymer.

4. The method of claim 1, wherein the temperature of the molten polymer blend is controlled to be at or about 50° C. above the melting point of the hard polymer.

5. The method of claim 1, wherein the ratio of the Melt Flow Rate of the soft polymer to the Melt Flow Rate of the hard polymer (soft:hard) at the melt temperature is at least or about 4.

6. The method of claim 1, wherein the hard polymer is selected from polyesters.

7. The method of claim 1, wherein the hard polymer is a polyester having a flex modulus of at least 2.0 GPa, and a melting point in the range of at or about 210-230° C.

8. The method of claim 1, wherein the hard polymer is selected from PBT, PPT, PET, PCT, PEN, and mixtures of these.

9. The method of claim 1, wherein the soft polymer is a copolyether ester elastomer.

10. The method of claim 1, wherein the soft polymer is a copolyether ester elastomer consisting essentially of a multiplicity of recurring long chain ester units and short chain ester units joined head-to-tail through ester linkages, wherein the long chain ester units are represented by the formula: 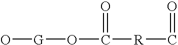
and the short chain ester units are represented by the formula: 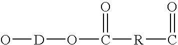
where G is a divalent radical remaining after removal of terminal hydroxyl groups from a poly(alkylene oxide) glycol [preferably poly(propylene oxide) glycol, or poly(butylene oxide) glycol] having a molecular weight of at or about 400-6000 Da and a carbon-to-oxygen ratio of about 2.0-4.3; R is a divalent radical remaining 4 after removal of carboxyl groups from a dicarboxylic acid having a molecular weight of less than at or about 300 and D is a divalent radical remaining after removal of hydroxyl groups from a diol having a molecular weight of less than at or about 250; provided said short chain ester units amount to about 15-95% by weight of the copolyether ester.

11. The method of claim 9, wherein the copolyether ester has a Shore D hardness of at or about 30 to at or about 60.

12. The method of claim 9, wherein the soft polymer is a copolyetherester consisting of PEG-capped PPG soft segments and PBT hard segments, and having the following characteristics:

| Property | Test method | Units | Value |
|---|---|---|---|
| Tensile stress @ 10% | ISO 527-1/-2 | MPa | 2.5 |
| strain | | | |
| Stress at break | ISO 527-1/-2 | MPa | 9.7 |
| Strain at break | ISO 527-1/-2 | % | 240 |
| Tensile modulus | ISO 527-1/-2 | MPa | 23 |
| Flexural modulus | | | |
| −40° C. | ISO 178 | MPa | 50 |
| 23° C. | | | 32 |
| 100° C. | | | 7 |
| Hardness, Durometer D | | | |
| 15 s | ISO 868 | | 26 |
| Maximum | | | 35 |
| Notched Izod Impact | ISO 180/1A | kJ/m² | NB |
| Strength −40° C. | | | |
| Brittleness temperature | ISO 974 | ° C. | −61 |
| Initial tear resist., die C | ISO 34 | kN/m | 58 |
| parallel | | | |
| Melting temperature | | | |
| 10° C./min | ISO 11357-1/-3 | ° C. | 154 |
| Vicat softening | ISO 306 | ° C. | 73 |
| temperature 10 N, | | | |
| 50° C./h | | | |
| Melt mass-flow rate 190° C., | ISO 1133 | g/10 min | 10 |
| 2.16 kg | | | |
| Density | ISO 1183 | Kg/m³ | 1150 |
| Water absorption, | ISO 62 | % | 5 |
| immersion 24 h | | | |

Test specimen for ISO 527-1/-2 is 1BA (2 mm) at 50 mm/min; all other ISO mechanical properties measured at 4 mm; ISO electrical properties measured at 2 mm.
All mechanical & electrical properties measured on injection-moulded specimens.
Test temperatures are 23° C. unless otherwise stated.

13. The method of claim 12, wherein the hard polymer is PBT.

14. The method of claim 1, wherein the hard polymer is selected from polyamides, and the soft polymer is selected from ionomers.

15. The method of claim 1, wherein the hard polymer is polyacetal, and the soft polymer is selected from thermoplastic polyurethane.

16. The method of claim 1, wherein the hard polymer is PBT, PET or a mixture of these, and the soft polymer is ETPV.

17. The method of claim 1, wherein the hard polymer is filled with a fibrous filler.

18. The method of claim 17, wherein the fibrous filler is selected from glass fibre, carbon fibres, graphite fibres, aramid fibres, ceramic fibres, metal fibres, and potassium titanate whiskers.

19. The method of claim 17, wherein the filler consists of fibres having an aspect ratio of from at or about 10 to at or about 1000.

20. The method of claim 17, wherein the filler is present in the hard polymer between at or about 10 to at or about 50 wt %, based on the total weight of the hard polymer composition.

21. The method of claim 1, wherein the ratio of the thickness of the thin part to the thick part (thin:thick) of the mould is less than at or about 1:4.

22. The method of claim 1, wherein the thickness of the thick part is less than at or about 6 mm.

23. The method of any one preceding claim, wherein during the initial injection phase, the pressure is chosen as for conventional injection moulding of the hard polymer, P₁;
during the pause phase, the pressure is decreased to a pressure at least at or about P₁/20; and
during the holding phase, the pressure is increased to a pressure of at or about P₁/5 to at or about P₁/3.

24. The method of claim 23, wherein P₁ is between at or about 900 to 2000 bar.

25. The method of claim 1, wherein the initial injection phase takes at or about 0.5 to 1.5 seconds; the pause phase takes at or about 0.5 to 1.5 seconds; and the holding phase takes at least at or about 2.5 seconds.

26. The method of claim 1, wherein the initial injection phase takes at or about 1 second; the pause phase takes at or about 1 second; and the holding phase takes at or about 5 seconds.

27. An injection moulded single component thermoplastic article comprising a blend of a hard polymer and a soft polymer, wherein the article has a thinner sealing edge having a relatively higher proportion of soft polymer, and a thicker structural part having a relatively higher proportion of the hard polymer.

28. The injection moulded article of claim 27, wherein the hard polymer has a melting point that is at least at or about 30° C. above the melting point of the soft polymer.

29. The injection moulded article of claim 27, wherein the hard polymer has a melting point that is at or about 40° C. above the melting point of the soft polymer.

30. The injection moulded article of claim 27, wherein the hard polymer is selected from polyesters.

31. The injection moulded article of claim 27, wherein the hard polymer is a polyester having a flex modulus of at least 2.0 GPa, and a melting point in the range of at or about 210-230° C.

32. The injection moulded article of claim 27, wherein the hard polymer is selected from PBT, PPT, PET, PCT, PEN, and mixtures of these.

33. The injection moulded article of claim 27, wherein the soft polymer is a copolyether ester elastomer.

34. The injection moulded article of claim 27, wherein the soft polymer is a copolyether ester elastomer consisting essentially of a multiplicity of recurring long chain ester units and short chain ester units joined head-to-tail through ester linkages, wherein the long chain ester units are represented by the formula: 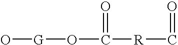
and the short chain ester units are represented by the formula: 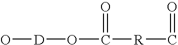
where G is a divalent radical remaining after removal of terminal hydroxyl groups from a poly(alkylene oxide) glycol [preferably poly(propylene oxide) glycol, or poly(butylene oxide) glycol] having a molecular weight of at or about 400-6000 Da and a carbon-to-oxygen ratio of about 2.0-4.3; R is a divalent radical remaining 4 after removal of carboxyl groups from a dicarboxylic acid having a molecular weight of less than at or about 300 and D is a divalent radical remaining after removal of hydroxyl groups from a diol having a molecular weight of less than at or about 250; provided said short chain ester units amount to about 15-95% by weight of the copolyether ester.

35. The injection moulded article of claim 33, wherein the copolyether ester has a Shore D hardness of at or about 30 to at or about 60.

36. The injection-moulded article of claim 27, wherein the soft polymer is a copolyetherester consisting of PEG-capped PPG soft segments and PBT hard segments, and having the following characteristics:

| Property | Test method | Units | Value |
|---|---|---|---|
| Tensile stress @ 10% | ISO 527-1/-2 | MPa | 2.5 |
| strain | | | |
| Stress at break | ISO 527-1/-2 | MPa | 9.7 |
| Strain at break | ISO 527-1/-2 | % | 240 |
| Tensile modulus | ISO 527-1/-2 | MPa | 23 |
| Flexural modulus | | | |
| −40° C. | ISO 178 | MPa | 50 |
| 23° C. | | | 32 |
| 100° C. | | | 7 |
| Hardness, Durometer D | | | |
| 15 s | ISO 868 | | 26 |
| Maximum | | | 35 |
| Notched Izod Impact | ISO 180/1A | KJ/m² | NB |
| Strength −40° C. | | | |
| Brittleness temperature | ISO 974 | ° C. | −61 |
| Initial tear resist., die C | ISO 34 | KN/m | 58 |
| parallel | | | |
| Melting temperature | | | |
| 10° C./min | ISO 11357-1/-3 | ° C. | 154 |
| Vicat softening | ISO 306 | ° C. | 73 |
| temperature 10 N, | | | |
| 50° C./h | | | |
| Melt mass-flow rate 190° C., | ISO 1133 | g/10 min | 10 |
| 2.16 kg | | | |
| Density | ISO 1183 | Kg/m³ | 1150 |
| Water absorption, | ISO 62 | % | 5 |
| immersion 24 h | | | |

Test specimen for ISO 527-1/-2 is 1BA (2 mm) at 50 mm/min; all other ISO mechanical properties measured at 4 mm; ISO electrical properties measured at 2 mm.
All mechanical & electrical properties measured on injection-moulded specimens.
Test temperatures are 23° C. unless otherwise stated.

37. The injection moulded article of any one of claim 36, wherein the hard polymer is PBT.

38. The injection moulded article of claim 27, wherein the hard polymer is selected from polyamides, and the soft polymer is selected from ionomers.

39. The injection moulded article of claim 27, wherein the hard polymer is polyacetal, and the soft polymer is selected from thermoplastic polyurethanes.

40. The injection moulded article of claim 27, wherein the hard polymer is PBT, PET or a mixture of these, and the soft polymer is ETPV.

41. The injection moulded article of claim 27, wherein the hard polymer is filled with a fibrous filler.

42. The injection moulded article of claim 41, wherein the fibrous filler is selected from glass fibre, carbon fibres, graphite fibres, aramid fibres, ceramic fibres, metal fibres, and potassium titanate whiskers.

43. The injection moulded article of claim 41, wherein the filler consists of fibres having an aspect ratio of from at or about 10 to at or about 1000.

44. The injection moulded article of claim 41, wherein the filler is present in the hard polymer between at or about 10 to at or about 50 wt %, based on the total weight of the hard polymer composition.

45. The injection moulded article of claim 27, wherein the ratio of the thickness of the thin part to the thick part (thin:thick) of the mould is less than at or about 1:4.

46. The injection moulded article of claim 27, wherein the thickness of the thicker part is less than at or about 6 mm.

47. The injection moulded article of claim 27, which is a cover for a gearbox.
